(19) United States
(12) Patent Application Publication
(10) Pub. No.: US 2011/0042487 A1
(43) Pub. Date: Feb. 24, 2011

(54) Discharge Implement of Reservoir for Portable Pressurized Sprayer

(76) Inventors: Ying Lin CAI, Guangdon (CN); Chao Fou HSU, Kaohsiung City (TW)

Correspondence Address: BACON & THOMAS, PLLC, 625 SLATERS LANE, FOURTH FLOOR, ALEXANDRIA, VA, 22314-1176, US

(21) Appl. No.: 12/848,517

(22) Filed: Aug. 2, 2010

Related U.S. Application Data
(60) Provisional application No. 61/272,116, filed on Aug. 18, 2009.

(51) Int. Cl. B05B 9/04; B65D 83/00; A01G 25/14

(52) U.S. Cl. 239/332; 222/401; 239/302; 239/375

(57) ABSTRACT

The present invention provides a discharge implement of reservoir for portable pressurized sprayer” comprising a discharging vent and a discharging hose. The discharging vent, which created in a vertical tucked buttress for a recessed sole of a portable reservoir, has an end exposed outwardly. The discharging hose has an end opening connected to the exposed end of the discharging vent and another end opening connected to a cylindrical discharging mount of a diaphragm compression pump respectively. If air is mingled in the compressed water, the air is immediately brought into the discharging hose and pass the discharging vent to flow into the portable reservoir with all damped moisture therein so that the damped moisture is completely eliminated without damped moisture remained therein. Thus, the drawbacks of harmfully affecting all parts therein and shortening service life for the portable pressurized sprayer incurred can be entirely avoided.

This application claims the benefit of provisional U.S. Patent Application Ser. No. 61/272,116, filed Aug. 18, 2009.

### FIELD OF THE PRESENT INVENTION

The present invention relates to a “discharge implement of reservoir for portable pressurized sprayer”, which can completely prevent and get rid of damped moisture and air mingled in the discharged water throughout the operation of the portable pressurized sprayer to surely keep dry therein. Thus, the drawbacks of harmfully affecting all parts therein and shortening the service life for the portable pressurized sprayer incurred by the damped moisture and mingled air can be entirely avoided.

### BACKGROUND OF THE INVENTION

Currently, for the conventional “portable pressurized sprayers” disclosed such as US patent issued numbers U.S. Pat. No. 7,118,050 and U.S. Pat. No. 5,303,866 as well as US patent publicized number US2006/0027680 (namely R.O.C. patent issued number 1253421 of Taiwan, R.O.C.), every structure for these foregoing conventional “portable pressurized sprayers” are almost similar. Referring to FIGS. 1 through 3, typical conventional portable pressurized sprayer comprises a water sprayer 1, a portable reservoir 2, a rechargeable battery 3 and a diaphragm compression pump 10, wherein said water sprayer 1 is a nozzle for spurting clean water out for cleaning target object, which is supplied from the portable reservoir 2 via a water intake hose 4, the diaphragm compression pump 10 and a water outtake hose 5; said portable reservoir 2, which colloquially called water tank, usually comprises a water replenish spout 21 on the top thereof for being supplied water, and a L-shaped sectional recessed sole 23 consisting of a horizontal planar bottom and a vertical right angle tucked buttress for conveniently accommodating the rechargeable battery 3 and a diaphragm compression pump 10 such that a water outlet 20 is disposed on the vertical tucked buttress of the recessed sole 23; said rechargeable battery 3, which is 24 VDC for powering the diaphragm compression pump 10, can be recharged by means of a cigar-lighter power receptacle of automobile; and said diaphragm compression pump 10, which compresses and drive water from the portable reservoir 2 to the water sprayer 1 via the water intake hose 4, includes a water inlet 11 connected to the water intake hose 4 and a water outlet 12 connected to the water sprayer 1. Accordingly, the appealing function of the conventional portable pressurized sprayer is to breakthrough the confinement of the water supply so that it can be brought to outdoor anywhere to perform cleaning job as long as the portable reservoir 2 is beforehand fed sufficient water W via water replenish spout 21 (as shown in FIG. 2). Once the conventional portable pressurized sprayer is brought to the cleaning job site, upon power being turning on for activating the diaphragm compression pump 10, the water W in the portable reservoir 2 is sucked into the diaphragm compression pump 10 for being compressed into compressed water W′ orderly via water outlet 20 of the portable reservoir 2, water intake hose 4 and water inlet 11 of the diaphragm compression pump 10; Then, the compressed water W′ is expelled out to the water sprayer 1 for cleaning job orderly via water outlet 12 of the diaphragm compression pump 10 and the water outtake hose 5 (as shown in FIG. 3).

However, a drawback of “air residual in the water intake hose 4” exists in the foregoing operation of conventional portable pressurized sprayer that when the portable reservoir 2 is replenished with new sufficient water W if all the stored water W in the portable reservoir 2 has been used up. Because the water intake hose 4 directs the water W from the water outlet 20 of the portable reservoir 2 to the water inlet 11 of the diaphragm compression pump 10, the air residual in the water intake hose 4 will be mingled with water W and flowed into the diaphragm compression pump 10. The air residual, which is flowed into the diaphragm compression pump 10, becomes an improper load for all parts of the diaphragm compression pump 10 with malignant result not only harmfully affecting the stable compression but also incurring malfunction due to intermittently and unstably harsh impact. Thereby, the service life of the diaphragm compression pump 10 will be shortened because the air residual therein as an improper load for all parts thereof.

In other words, the foregoing “air residual in the water intake hose 4”, which has being existed in all disclosed conventional portable pressurized sprayers aforesaid all the way, has never been discovered and remedied until the present invention by the inventor. Having addressed to the issue of how to eliminating the foregoing “air residual in the water intake hose 4” during every replenishing water into the portable reservoir 2, the inventor of the present invention has actively undertaken research and development for a long time in experimental test. Eventually, an innovative solution of the present invention is successfully worked out. Since success of the present invention, the inventor has submitted a patent application to the China Patent Office with register number of 200710195188.X (publicized number of CN101382128A). Referring to FIGS. 4 and 5, the specific structure for the foregoing patent application to the China Patent Office comprises a cylindrical discharging mount 30 and a pneumatic hollow plunger 40, wherein: Said cylindrical discharging mount 30, which is a hollow cylinder, has a first cylindrical discharging chamber 31 and a second cylindrical discharging chamber 32 disposed in the lower section and upper section thereof in fluid communicable to each other such that the inner diameter of the first cylindrical discharging chamber 31 is bigger than that of the second cylindrical discharging chamber 32, a discharging vent 34 disposed in the central top thereof in facing towards the second cylindrical discharging chamber 32, and an air passage 33 disposed in the bottom wall thereof such that the first cylindrical discharging chamber 31 is fluid communicable with the water outlet 12 of the diaphragm compression pump 10; Said pneumatic hollow plunger 40, which is a bucket-like hollow piston, includes a top opening end 41, a bottom flanged hatch end 42, a contained compressed spring 43, a side vent 44 and a sealing O-ring 45 of water-tight, wherein the opening end 41 is fittingly contained in the second cylindrical discharging chamber 32 in sliding manner while the flanged hatch end 42, whose flange sole is corrugated in dial manner (not shown in figures), is properly contained in the first cylindrical discharging chamber 31 in sliding manner with flange sole thereof facing to the air passage 33 of the cylindrical discharging mount 30, the compressed spring 43 is snugly inserted in the pneumatic hollow plunger 40 in facing to the opening end 41, the side vent 44 is created at the side wall of the pneumatic hollow plunger 40 near to the flanged hatch end 42 such that it is blocked if the pneumatic hollow plunger 40 is pushed backwardly all the way while it is able to pass fluid in the first cylindrical discharging chamber 31 if the pneumatic hollow plunger 40 is pushed forwardly all the way and the sealing O-ring 45 is placed around the peripheral of the pneumatic hollow plunger 40 in contact with the top rim of the flanged hatch end 42 (as shown in enlarged view of FIG. 5).

The operation modes for the foregoing patent application to the China Patent Office with register number of 200710195188.X (publicized number of CN101382128A) are demonstrated in FIGS. 6 and 7. In normal mode of no air A mingled in the compressed water W′, the pressure of the compressed water W′ in the water outlet 12 of the diaphragm compression pump 10 is higher than the resilient force of the compressed spring 43 so that the flanged hatch end 42 of the pneumatic hollow plunger 40 is acted and pushed backwardly all the way by the pressure of the compressed water W′ at the air passage 33 of the cylindrical discharging mount 30, certain partial compressed water W′ in the water outlet 12 will flow into the first cylindrical discharging chamber 31 via air passage 33 and the pneumatic hollow plunger 40 will be pushed into the second cylindrical discharging chamber 32 all the way until the sealing O-ring 45 on the flanged hatch end 42 closely contact with distal inner end wall of the first cylindrical discharging chamber 31 in water-tight manner so that no compressed water W′ in the first cylindrical discharging chamber 31 can flow into the second cylindrical discharging chamber 32 and no more compressed water W′ in the water outlet 12 can further flow into the first cylindrical discharging chamber 31 via air passage 33. Thus, all the following compressed water W′ will normally flow out via water outlet 12 for proper purpose (as shown in solid line indicating arrowhead in FIG. 6). In abnormal mode with air A mingled in the compressed water W′, the pressure of the compressed water W′ in the water outlet 12 of the diaphragm compression pump 10 is lower than the resilient force of the compressed spring 43 so that the flanged hatch end 42 of the pneumatic hollow plunger 40 is acted and pushed forwardly all the way by the resilient force of the compressed spring 43 until the corrugated flange sole of the flanged hatch end 42 contacts with proximal inner end wall of the first cylindrical discharging chamber 31 so that the side vent 44 at the side wall of the pneumatic hollow plunger 40 is moved in the first cylindrical discharging chamber 31 and able to pass fluid. Accordingly, the air A mingled in the compressed water W′ firstly will pass the corrugated flange sole of the flanged hatch end 42 via the air passage 33 then flow into the first cylindrical discharging chamber 31; Secondly, the air A mingled in the compressed water W′ will flow into the pneumatic hollow plunger 40 via the side vent 44 now moved in the first cylindrical discharging chamber 31; And finally, the air A mingled in the compressed water W′ will be discharged out the diaphragm compression pump 10 orderly via the opening end 41 of the pneumatic hollow plunger 40 and the discharging vent 34 of the cylindrical discharging mount 30 to achieve the discharging effect for the air A mingled in the compressed water W′ (as shown in dashed line indicating arrowhead in FIG. 7). After all the air A mingled in the compressed water W′ have been discharged out of the diaphragm compression pump 10, the operation status is resumed to normal mode of no air A mingled in the compressed water W′ so that the pneumatic hollow plunger 40 in the cylindrical discharging mount 30 is again forced and pushed backwardly into the second cylindrical discharging chamber 32 as normal compression and discharging position (as shown in FIG. 6) to allow the diaphragm compression pump 10 being resumed to normal compression and discharging operation.

After mass production via molding process for the foregoing patent application to the China Patent Office with register number of 200710195188.X (publicized number of CN101382128A), the discharging effect for the air A mingled in the compressed water W′ has been tested to achieve the expected efficiency satisfactorily. However, the discharged air A out the cylindrical discharging mount 30 of the diaphragm compression pump 10 is found to have moisture slightly damped. The damped moisture in the discharged air A becomes a new issue of the portable pressurized sprayer with malignant result not only harmfully affecting all parts therein but also shortening the service life thereof. Accordingly, the inventor of the present invention must address to the new issue of the damped moisture in the discharged air A and devise a further and thorough solution of the present invention.

### SUMMARY OF THE INVENTION

The primary object of the present invention is to provide a “discharge implement of reservoir for portable pressurized sprayer” comprising a discharging vent and a discharging hose, wherein said discharging vent, which run through a vertical tucked buttress for a recessed sole of a portable reservoir, has an end exposed outwardly; and said discharging hose has an end opening connected to the exposed end of the discharging vent and another end opening connected to a cylindrical discharging mount of a diaphragm compression pump respectively. If air is mingled in the compressed water, the air will be immediately brought into the discharging hose and pass the discharging vent to flow into the portable reservoir with all damped moisture therein so that the damped moisture in the discharged air can be completely eliminated throughout the operation of the portable pressurized sprayer to make sure no damped moisture remained therein. Thus, the drawbacks of harmfully affecting all parts therein and shortening the service life for the portable pressurized sprayer incurred by the damped moisture in the discharged air can be entirely avoided.

### BRIEF DESCRIPTION OF THE DRAWINGS

FIG. 1 is an exploded perspective view for a conventional portable pressurized sprayer.

FIG. 2 is an exploded perspective view for a conventional portable pressurized sprayer.

FIG. 3 is a sectional view taken along the line 3-3 of the FIG. 2.

FIG. 4 is a partial perspective view showing a diaphragm compression pump for a conventional portable pressurized sprayer.

FIG. 5 is a sectional view taken along the line 5-5 of the FIG. 4.

FIG. 6 is the first operational schematic view showing a diaphragm compression pump for a conventional portable pressurized sprayer.

FIG. 7 is the second operational schematic view showing a diaphragm compression pump for a conventional portable pressurized sprayer.

FIG. 8 is an exploded perspective view in cross section manner for the first exemplary preferred embodiment of the present invention.

FIG. 9 is an operational schematic view in cross section manner for the first exemplary preferred embodiment of the present invention.

FIG. 10 is a sectional view showing serrate barbed peripheral of a protruding hollow fitting tube for the first exemplary preferred embodiment of the present invention.

FIG. 11 is an exploded perspective view in cross section manner for the second exemplary preferred embodiment of the present invention.

FIG. 12 is a planar exploded schematic view in cross section manner showing another discharging implement consisted of a discharging vent and a discharging hose for the second exemplary preferred embodiment of the present invention.

FIG. 13 is a planar assembled schematic view in cross section manner showing another discharging implement consisted of a discharging vent and a discharging hose for the second exemplary preferred embodiment of the present invention.

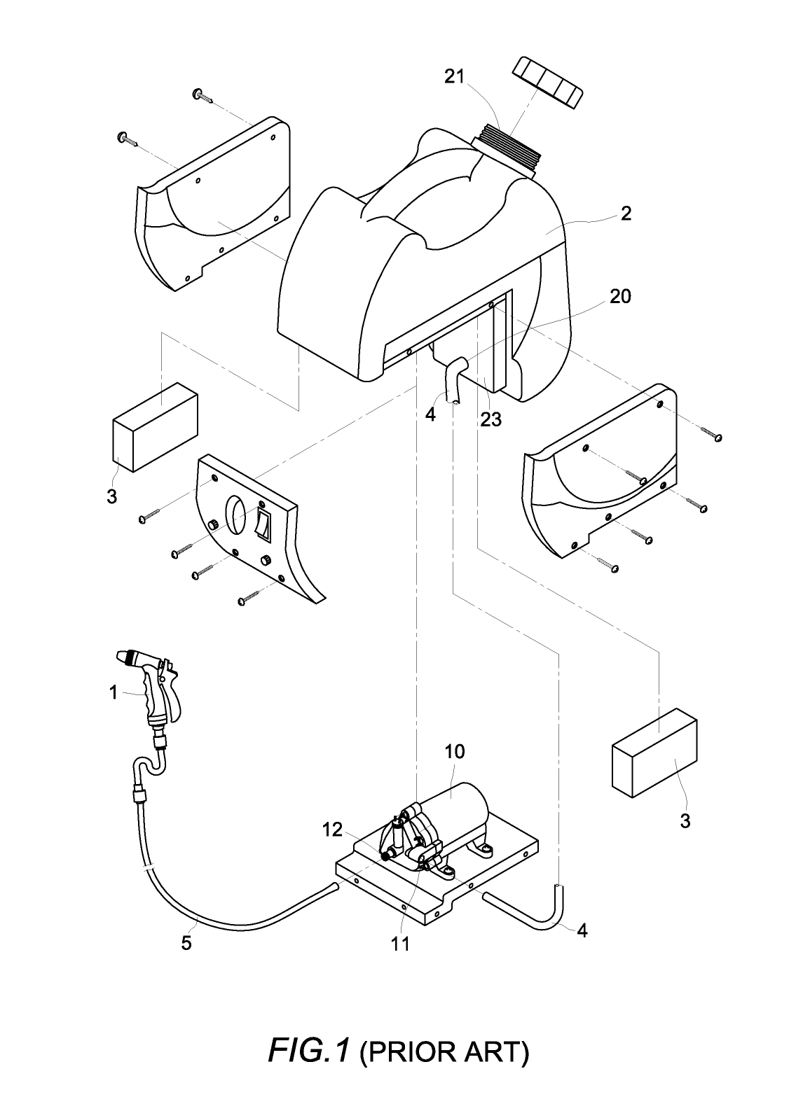

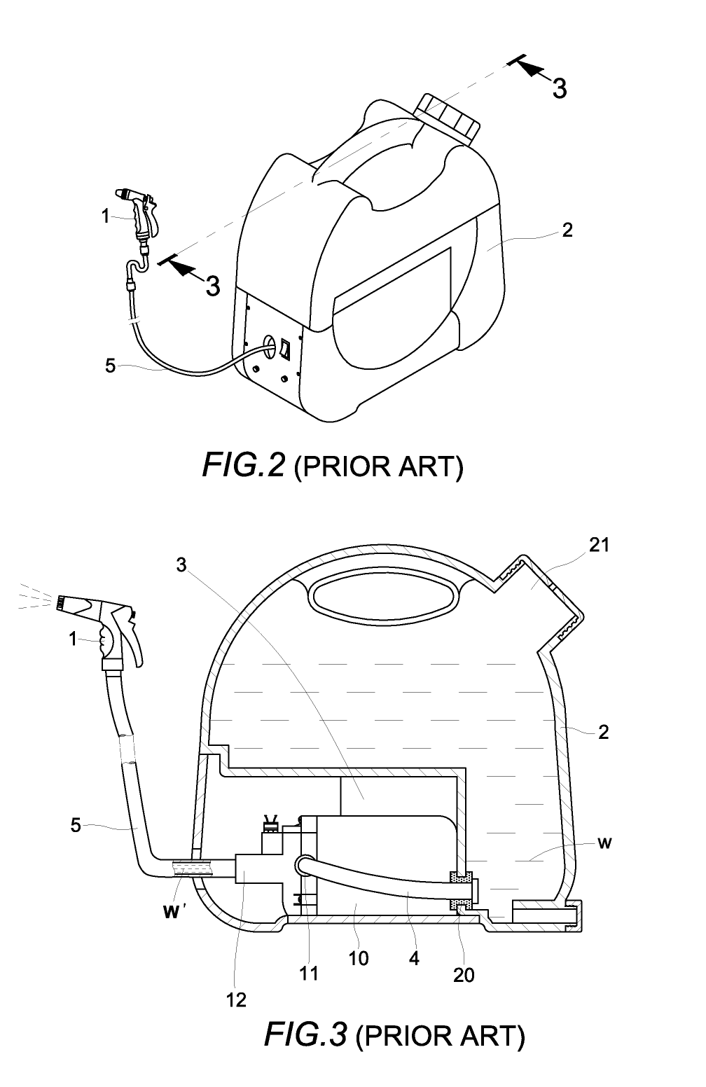

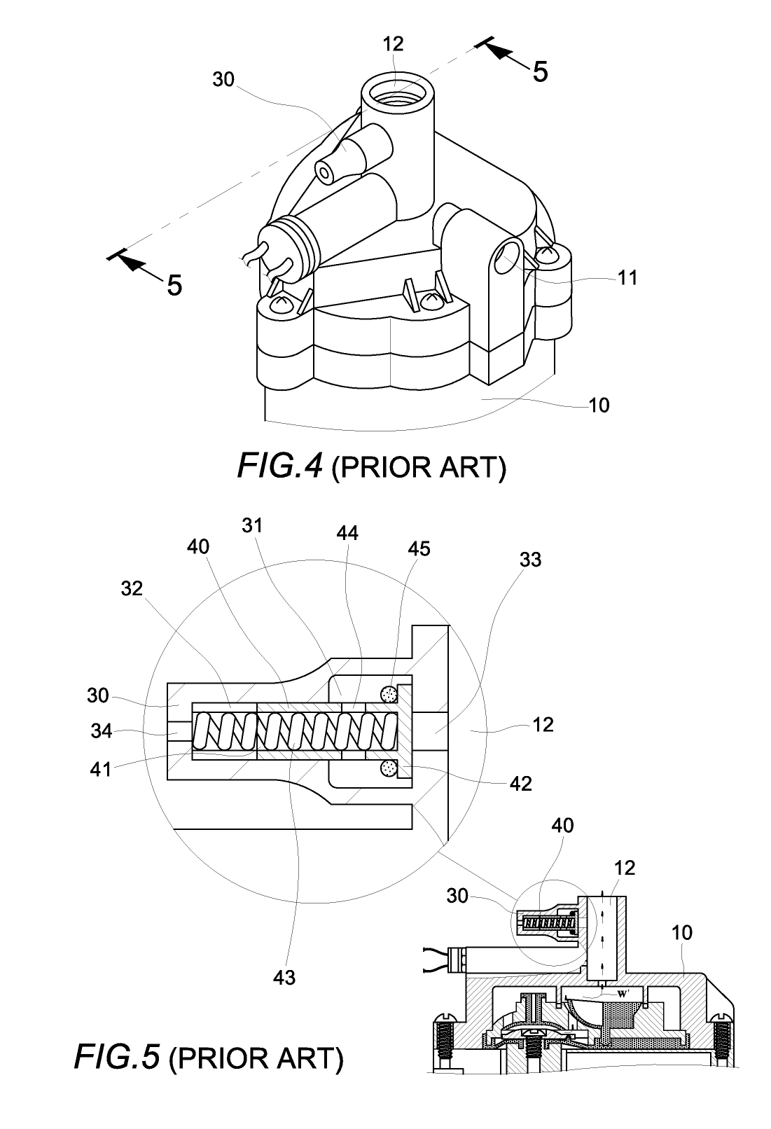

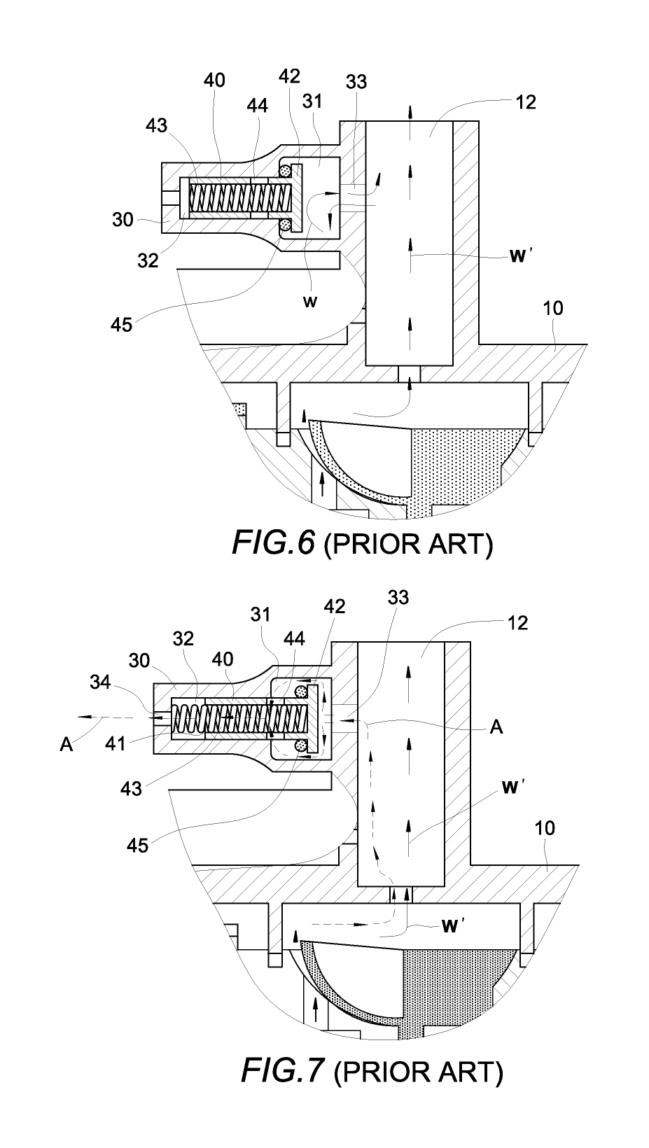

### DETAILED DESCRIPTION OF THE PREFERRED EMBODIMENTS

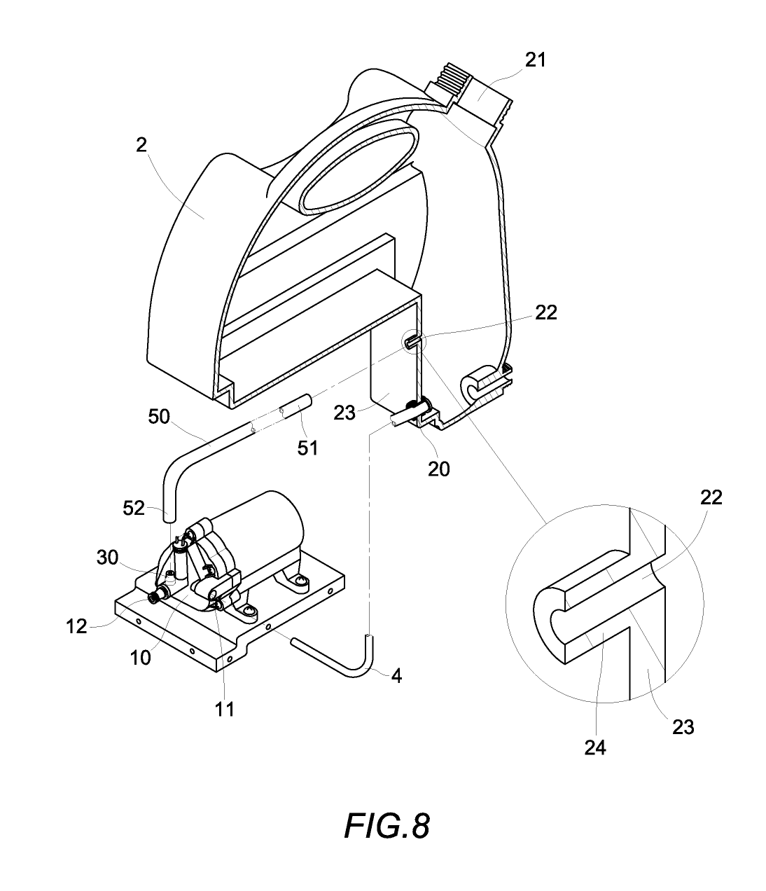

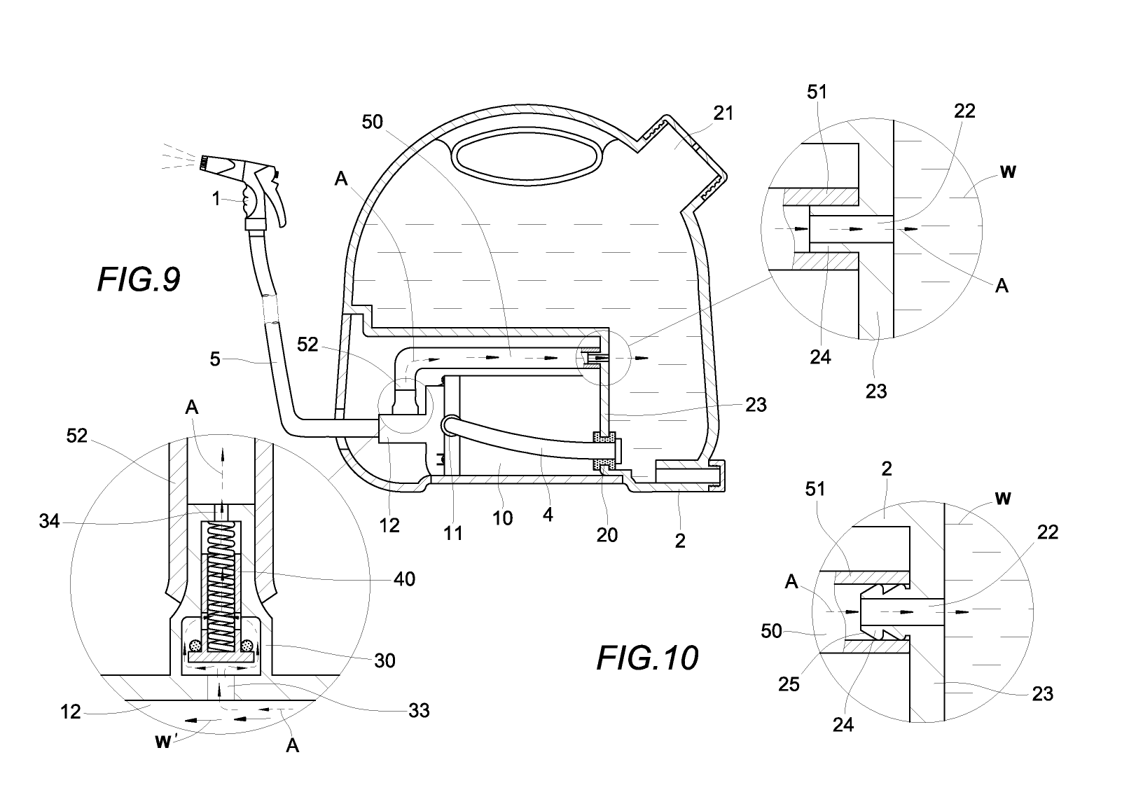

Referring to FIGS. 8 and 9, the “discharge implement of reservoir for portable pressurized sprayer” of the present invention that includes a reservoir 2 and a recess 23 in said reservoir 2 for receiving a diaphragm compression pump 10, said diaphragm compression pump 10 having a water inlet 11 and a water outlet 12, said discharge implement comprises a discharging vent 22 and a discharging hose 50, wherein said discharging vent 22 extends through a wall of the recess 23 of the reservoir 2, and has a protruding hollow fitting tube 24 exposed outwardly under the horizontal planar bottom of the recess 23 such that the outer diameter of the protruding hollow fitting tube 24 is slightly smaller than the inner diameter of the discharging hose 50 for securely coupling each other without any possibility of detaching off (as shown in enlarged view of FIG. 9); and said discharging hose 50 has a first opening 51 connected to the protruding hollow fitting tube 24 of the discharging vent 22 and a second opening 52 connected to the cylindrical discharging mount 30 of the diaphragm compression pump 10 respectively (as shown in FIG. 8). In practical operation, if air A is mingled in the output compressed water W′ of the diaphragm compression pump 10, firstly, the air A will be brought into the discharging hose 50 via the discharging vent 34 in the cylindrical discharging mount 30 of the diaphragm compression pump 10; secondly, the air A will pass the discharging vent 22 of the reservoir 2 via discharging hose 50; and finally, the air A will flow into the reservoir 2 with all damped moisture therein so that the damped moisture in the discharged air A can be completely eliminated throughout the operation of the portable pressurized sprayer to make sure no damped moisture remained therein. Thus, the drawbacks of harmfully affecting all parts therein and shortening the service life for the portable pressurized sprayer incurred by the damped moisture in the discharged air A disclosed above can be entirely avoided.

Referring to FIG. 10, a serrate barbed exterior surface 25 with plural barbed ramps is further formed on the protruding hollow fitting tube 24 of the discharging vent 22 such that the external major diameter of the serrate barbed exterior surface 25 approximately equals the inner diameter of the discharging hose 50 to allow the second opening 52 of the discharging hose 50 can securely couple the serrate barbed exterior surface 25 of the discharging vent 22 without any possibility of detaching off.

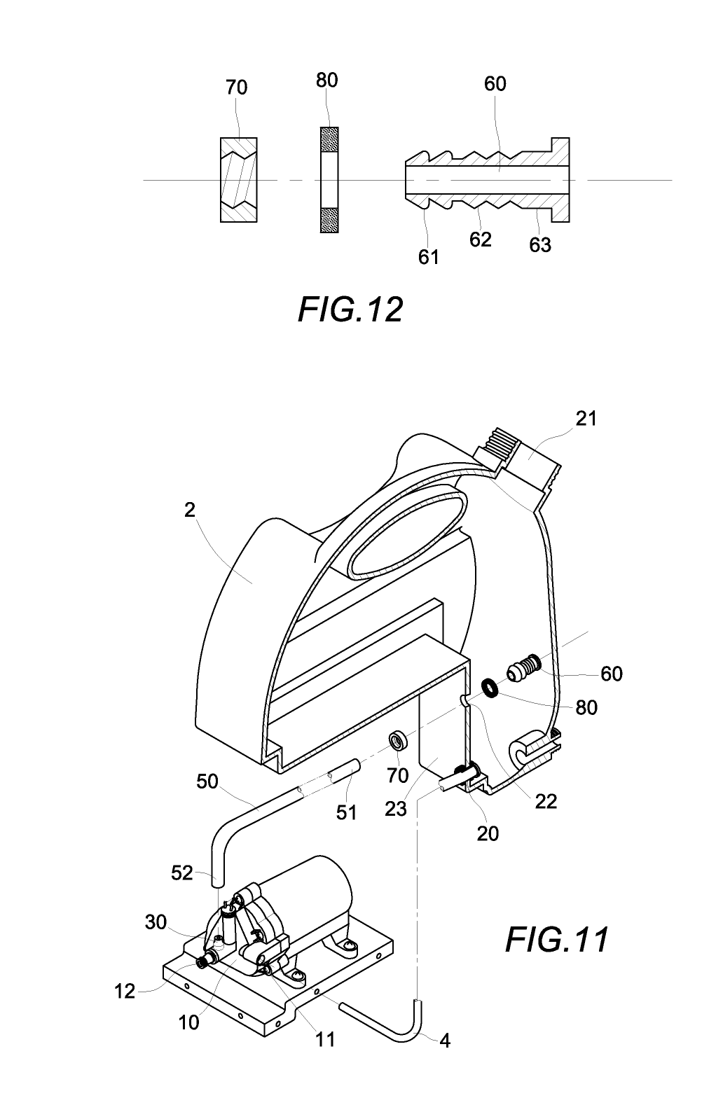

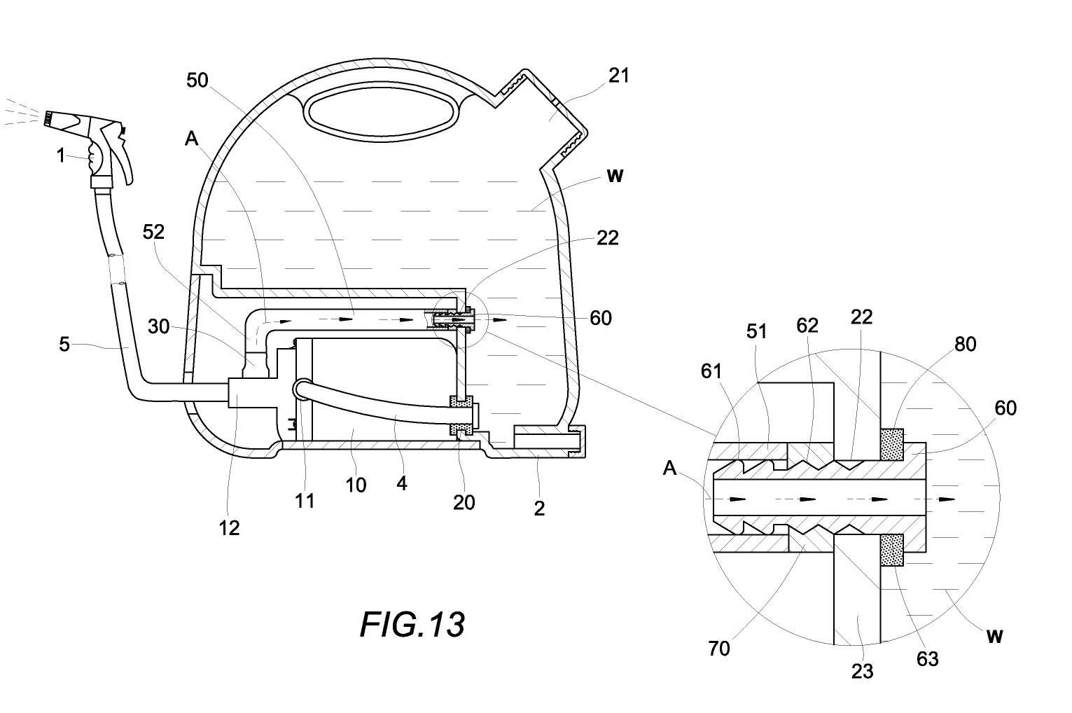

Referring to FIGS. 11 through 13, the connecting means for discharge implement of the discharging vent 22 and discharging hose 50 is further adapted into comprising a T-shaped sectional flanged hollow tube 60, a coupling nut 70 and a ring-like sandwiched rubber annular washer 80 of water-tight, wherein said T-shaped sectional flanged hollow tube 60 has a serrate barbed peripheral 61 with plural barbed ramps is further formed on the front section thereof, a plurality of male external threads 62 are further formed on the middle section thereof, and a tubular neck 63 of even outer diameter is further formed on the rear section thereof (as shown in FIG. 12). For assembly process, firstly, sleeve downwardly the rubber annular washer 80 on the tubular neck 63 up contacting with top rim of the T-shaped sectional flanged hollow tube 60 by orderly passing the serrate barbed peripheral 61 and male external thread 62; secondly, screw the nut 70 on the male external thread 62 of the T-shaped sectional flanged hollow tube 60 in engagement manner; and finally, securely couple the first opening 51 of the discharging hose 50 with the serrate barbed peripheral 61 of the T-shaped sectional flanged hollow tube 60 in firm manner to achieve the tight coupling effect each other without any possibility of detaching off (as shown in enlarged view of FIG. 13).

In conclusion of the disclosure heretofore, the critical drawback of the damped moisture in the discharged air existed in the conventional portable pressurized sprayer is solved and deleted by the innovative simple contrivance of the present invention. As the present invention possesses patentable criterion of novelty, non-obviousness of the prior arts, and practical applicable usage, we submit the patent application in accordance with the related patent laws.

What is claimed is:

1. A discharge implement of a reservoir for a portable pressurized sprayer that includes a reservoir and a recess in said reservoir for receiving a diaphragm compression pump, said diaphragm compression pump having a water inlet and a water outlet, said discharge implement comprising: a discharging vent and a discharging hose, wherein said discharging vent extends through a wall of said recess, and said discharging hose has a first end opening connected to said discharging vent and a second end opening connected to a cylindrical discharging mount at the water outlet of the diaphragm compression pump,
whereby said discharging hose provides a passage for air passing through said cylindrical discharging mount of said water outlet to discharge back to said reservoir through said discharging vent.

2. The discharge implement of a reservoir for a portable pressurized sprayer as claimed in claim 1, wherein said first end of the discharging hose is connected to said discharging vent by a protruding hollow fitting tube extending into said recess from said wall, and an outer diameter of the protruding hollow fitting tube is slightly smaller than the inner diameter of the discharging hose to enable said hose to be tightly fitted onto said protruding hollow fitting tube.

3. The discharge implement of a reservoir for a portable pressurized sprayer as claimed in claim 2, wherein the protruding hollow fitting tube has a serrate barbed exterior surface with plural barbed ramps such that an external major diameter of the serrate barbed exterior surface peripheral approximately equals the inner diameter of the discharging hose, said barbed ramps preventing detachment of the hose from the protruding hollow fitting tube.

4. The discharge implement of a reservoir for a portable pressurized sprayer as claimed in claim 1, wherein the first end of said discharging hose is connected to said discharging vent by a T-shaped sectional flanged hollow tube extending through said wall of said recess, said hollow tube including a peripheral surface to which said discharging hose is connected.

5. The discharge implement of a reservoir for a portable pressurized sprayer as claimed in claim 4, wherein said hollow tube is externally threaded, and further comprising a coupling nut and an annular water tight washer for securing said discharge hose to said hollow tube by threading said coupling nut onto said hollow tube and sandwiching said washer between a flange of the T-shaped section and said wall.

6. The discharge implement of a reservoir for a portable pressurized sprayer as claimed in claim 5, wherein said hollow tube has a serrate barbed peripheral surface with a plurality of barbed ramps formed on a front section of said hollow tube for retaining said discharge hose on said hollow tube, external threads for receiving said nut are formed on a middle section of said hollow tube, and a rear section of said hollow tube forms a tubular neck of even outer diameter extending from said middle section to said flange.

7. The discharge implement of a reservoir for a portable pressurized sprayer as claimed in claim 4, wherein said hollow tube has a serrate barbed peripheral surface with a plurality of barbed ramps for retaining said discharge hose on said hollow tube.

8. The discharge implement of a reservoir for a portable pressurized sprayer as claimed in claim 1, wherein the cylindrical discharging mount to which the second end of the discharging hose is connected includes an air inlet, and air outlet, and a movable member, said movable member being biased by a compression spring to close said air inlet, whereby fluid pressure in said water outlet of the diaphragm compression pump moves said movable member away from said air inlet to permit passage of air from said air inlet to said discharging hose through said air outlet, and whereby increasing pressure in said water outlet due as air is discharged causes said movable member to move towards said air outlet until all of said air is discharged and said movable member blocks said air outlet.
